(19) United States
(12) Patent Application Publication
(10) Pub. No.: US 2026/0095720 A1
(43) Pub. Date: Apr. 2, 2026

(54) METHOD FOR MATCHING LEFT AND RIGHT CHANNELS OF EARPHONES, CLIP-ON EARPHONES AND STORAGE MEDIUM

(71) Applicant: GOERTEK INC., Weifang (CN)

(72) Inventor: Haiyong WANG, Weifang (CN)

(21) Appl. No.: 19/412,220

(22) Filed: Dec. 8, 2025

Related U.S. Application Data
(63) Continuation of application No. PCT/CN2025/084582, filed on Mar. 25, 2025.

(30) Foreign Application Priority Data
Mar. 28, 2024 (CN) 202410370106.4

(51) Int. Cl. H04S 7/00; H04R 1/02; H04R 1/10

(52) U.S. Cl. CPC H04S 7/304; H04R 1/028; H04R 1/1008; H04R 1/105

(57) ABSTRACT

A method for matching left and right channels of an earphones, a clip-on earphones, and a storage medium. The method includes: obtaining, in response to detecting that a target earphone is worn, three-axis acceleration information detected by the three-axis acceleration sensor and touch sensing information detected by the contact sensor, wherein the target earphone is the first earphone or the second earphone; determining a touch distribution position where touch occurs in the speaker compartment region according to the touch sensing information; and adjusting a channel of a speaker of the target earphone according to the three-axis acceleration information and the touch distribution position, such that the channel of the target earphone matches a wearing position.

### CROSS-REFERENCE TO RELATED APPLICATIONS

This application is a continuation application of International Application No. PCT/CN2025/084582, filed on Mar. 25, 2025, which claims priority to Chinese Patent Application No. 202410370106.4, filed on Mar. 28, 2024. All of the aforementioned applications are incorporated herein by reference in their entireties.

### TECHNICAL FIELD

The present application relates to the technical field of earphone, and in particular to a method for matching left and right channels of an earphone, a clip-on earphone, and a storage medium.

### BACKGROUND

With the development of new technologies, open wearable stereo (OWS) earphones, such as clip-on earphones, have become increasingly popular. Compared with true wireless stereo (TWS) earphones, clip-on earphones are more ear-friendly, do not cause hearing damage, provide a more comfortable wearing experience, and are more suitable for long-term use. Because clip-on OWS earphones are worn without being inserted into the ear, they can have identical left and right designs and can be worn interchangeably, which distinguishes them from conventional in-ear earphones.

The clip-on earphones include a left earphone and a right earphone. The left earphone outputs a left channel, and the right earphone outputs a right channel. When the stereo earphones are worn on a user's ears, the left earphone is in contact with the user's left ear, and the right earphone is in contact with the user's right ear, so that the left ear receives the left channel and the right ear receives the right channel. During wearing, the relative positions of the left earphone and the right earphone cannot be interchanged; otherwise, it directly affects the fidelity of the sound source and the resolution of the audio frequency.

To achieve a perfect sound output effect, the user must first identify the left and right sides before wearing the clip-on earphones. The current solution is to mark the clip-on earphones with identifiers such as “L” and “R”. However, this requires manual identification before wearing to avoid reversed placement, which brings inconvenience to the user.

### SUMMARY

The main objective of the present application is to provide a method for matching the left and right channels of earphones, a clip-on earphone and a storage medium, aiming to solve the technical problem in the related art that requires manually confirming whether the left and right headphones are worn correctly, which leads to poor usability of clip-on earphones.

In order to achieve the above objective, the present application provides a method for matching left and right channels of earphones, which is applied to a clip-on earphone, where a first earphone and a second earphone of the clip-on earphone are each provided with a three-axis acceleration sensor, and the method includes:
obtaining, in response to detecting that a target earphone is worn, three-axis acceleration information detected by the three-axis acceleration sensor and touch sensing information detected by the contact sensor, where the target earphone is the first earphone or the second earphone;
determining a touch distribution position where touch occurs in the speaker compartment region according to the touch sensing information; and
adjusting a channel of a speaker of the target earphone according to the three-axis acceleration information and the touch distribution position, such that the channel of the target earphone matches a wearing position.

In an embodiment, the adjusting the channel of the speaker of the target earphone according to the three-axis acceleration information and the touch distribution position includes:
determining a wearing position corresponding to the target earphone according to the three-axis acceleration information and the touch distribution position; and
adjusting the channel of the speaker of the target earphone based on the wearing position corresponding to the target earphone, such that a left channel corresponds to the earphone in a left ear wearing position, and/or a right channel corresponds to the earphone in a right ear wearing position.

In an embodiment, the speaker compartment region includes a first region and a second region opposite to the first region, and the determining the wearing position corresponding to the target earphone according to the three-axis acceleration information and the touch distribution position includes:
determining a component direction of the three-axis acceleration information in a vertical direction;
determining a first touch area corresponding to the first region and a second touch area corresponding to the second region according to the touch distribution position;
determining wearing posture information corresponding to the target earphone according to the first touch area, the second touch area, and the component direction; and
determining the wearing position corresponding to the target earphone according to the wearing posture information.

In an embodiment, the determining the wearing posture information corresponding to the target earphone according to the first touch area, the second touch area, and the component direction includes:
in response to that the first touch area is greater than the second touch area and a component direction of the three-axis acceleration information in the vertical direction is a positive direction of a Z axis, determining that wearing posture information corresponding to the target earphone is a first posture; and
in response to that the first touch area is less than the second touch area and the component direction of the three-axis acceleration information in the vertical direction is a negative direction of the Z axis, determining that wearing posture information corresponding to the target earphone is a second posture.

In an embodiment, the method further includes: in response to that the first touch area is less than the second touch area and the component direction of the three-axis acceleration information in the vertical direction is a positive direction of the Z axis, or
in response to that the first touch area is greater than the second touch area and the component direction of the three-axis acceleration information in the vertical direction is a negative direction of the Z axis, determining a component value of the three-axis acceleration information in the vertical direction; and
determining the wearing posture information corresponding to the target earphone according to the component direction and the component value.

In an embodiment, the determining the wearing posture information corresponding to the target earphone according to the component direction and the component value includes:
in response to that the component direction of the three-axis acceleration information in the vertical direction is the positive direction of the Z axis and the component value matches a gravity acceleration value, determining that the wearing posture information corresponding to the target earphone is the first posture; and
in response to that the component direction of the three-axis acceleration information in the vertical direction is the negative direction of the Z axis and the component value matches the gravity acceleration value, determining that the wearing posture information corresponding to the target earphone is the second posture.

In an embodiment, after determining the component value of the three-axis acceleration information in the vertical direction, the method further includes:
in response to that the component value matches a gravity acceleration value, determining the wearing posture information corresponding to the target earphone according to the component direction and the component value; and
in response to that the component value does not match the gravity acceleration value, determining wearing posture information corresponding to a reference earphone, and determining the wearing posture information corresponding to the target earphone according to the wearing posture information corresponding to the reference earphone, where the reference earphone is the earphone of another channel corresponding to the target earphone in the clip-on earphone.

In an embodiment, the determining the wearing posture information corresponding to the target earphone according to the wearing posture information corresponding to the reference earphone includes:
in response to that the wearing posture information corresponding to the reference earphone is the second posture, determining that the wearing posture information corresponding to the target earphone is the first posture; and
in response to that the wearing posture information corresponding to the reference earphone is the first posture, determining that the wearing posture information corresponding to the target earphone is the second posture.

In an embodiment, the determining the wearing position corresponding to the target earphone according to the wearing posture information includes:
in response to that the wearing posture information is the first posture, determining that the wearing position corresponding to the target earphone is a left ear wearing position; and
in response to that the wearing posture information is the second posture, determining that the wearing position corresponding to the target earphone is a right ear wearing position.

In an embodiment, a type of the contact sensor is a capacitive touch sensor or a resistive touch sensor.

The present application further provides a clip-on earphones, which is a physical device and includes a memory, a processor, a behind-the-ear compartment, a speaker compartment, and a connecting bridge connecting the behind-the-ear compartment and the speaker compartment, where:
the speaker compartment is provided with an acoustic module and a contact sensor, the acoustic module includes a speaker, and the behind-the-ear compartment is provided with a power supply module and an acceleration sensor;
the power supply module is configured to provide power to the clip-on earphone;
the acceleration sensor is configured to detect three-axis acceleration information of the clip-on earphone;
the contact sensor is configured to detect touch information;
the memory is configured to store a program for matching left and right channels of earphones; and
the processor is configured to execute the program for matching left and right channels of earphones and, when executing the program for matching left and right channels of earphones, implement the method for matching left and right channels of earphones

The present application further provides a computer-readable storage medium, on which a program for implementing a method for matching left and right channels of earphones is stored, where when the program for implementing the method for matching left and right channels of earphones is executed by a processor, the above-mentioned method for matching left and right channels of earphones is implemented.

The present application further provides a computer program product, including a computer program, which implements the above-mentioned method for matching left and right channels of earphones when executed by a processor.

The present application discloses a method for matching left and right channels of earphones, clip-on earphones, and a storage medium. The method for matching left and right channels of earphones is applied to clip-on earphones, where a first earphone and a second earphone of the clip-on earphones are each provided with a three-axis acceleration sensor, and a speaker compartment region of the first earphone and a speaker compartment region of the second earphone are each provided with a contact sensor. A technical solution of the method for matching left and right channels of earphones of the present application is to obtain three-axis acceleration information detected by the three-axis acceleration sensor and touch sensing information detected by the contact sensor in response to detecting that a target earphone is worn, where the target earphone is the first earphone or the second earphone, determine a touch sensing distribution position where touch sensing is generated in the speaker compartment region according to the touch sensing information, and adjust a channel of a speaker of the target earphone according to the three-axis acceleration information and the touch sensing distribution position so that the channel of the target earphone matches a wearing position, so that a left channel corresponds to the earphone in a left ear wearing position and a right channel corresponds to the earphone in a right ear wearing position, thereby implementing automatic matching of left and right channels with left and right ears, overcoming an inconvenience in related art in which a user needs to first manually confirm identifiers such as “L” and “R” marked on earphones to avoid wearing in a reverse manner, improving use convenience of the clip-on earphones, effectively enabling that before wearing the earphones a user does not need to distinguish between left and right ears, that is, no matter how the clip-on earphones are worn, left and right channel sound signals obtained are always correct, and improving a listening effect of the user.

### BRIEF DESCRIPTION OF THE DRAWINGS

FIG. 1 is a flowchart of a method for matching left and right channels of earphones according to an embodiment of the present application.

FIG. 2 is a flowchart of the method for matching left and right channels of earphones according to an embodiment of the present application.

FIG. 3 is a flowchart of the method for matching left and right channels of earphones according to an embodiment of the present application.

FIG. 4 is a flowchart of the method for matching left and right channels of earphones according to an embodiment of the present application.

FIG. 5 is a flowchart of the method for matching left and right channels of earphones according to an embodiment of the present application.

FIG. 6 is a flowchart of the method for matching left and right channels of earphones according to an embodiment of the present application.

FIG. 7 is a flowchart of the method for matching left and right channels of earphones according to an embodiment of the present application.

FIG. 8 is a flowchart of the method for matching left and right channels of earphones according to an embodiment of the present application.

FIG. 9 is a flowchart of the method for matching left and right channels of earphones according to an embodiment of the present application.

FIG. 10 is a flowchart of the method for matching left and right channels of earphones according to an embodiment of the present application.

FIG. 11 is a schematic diagram of a wearing posture of a clip-on earphones in a worn state from one view according to an embodiment of the present application.

FIG. 12 is a schematic diagram of the clip-on earphones in one view according to an embodiment of the present application.

FIG. 13 is a schematic diagram of the clip-on earphones in another view according to an embodiment of the present application.

FIG. 14 is a diagram showing three-axis acceleration information when clip-on earphones are worn on left and right ears according to an embodiment of the present application.

FIG. 15 is a schematic diagram of a user wearing a target earphone according to an embodiment of the present application.

FIG. 16 is a schematic structural diagram of a target earphone according to an embodiment of the present application.

FIG. 17 is a diagram showing touch sensing of a touch sensing band of a target earphone in a wearing scenario according to an embodiment of the present application.

The realization of the purpose, functional features and advantages of the present application will be further described with reference to the embodiments and the accompanying drawings.

### DETAILED DESCRIPTION OF THE EMBODIMENTS

To make the above-mentioned purposes, features, and advantages of the present application more clearly understood, the technical solutions in the embodiments of the present application will be clearly and completely described below in conjunction with the accompanying drawings in the embodiments of the present application. Obviously, the described embodiments are only part of the embodiments of the present application, not all of the embodiments. Based on the embodiments in the present application, all other embodiments obtained by those skilled in the art without making any creative work are within the scope of protection of the present application.

A clip-on earphone includes a left earphone and a right earphone. The left earphone is configured to output a left channel, and the right earphone is configured to output a right channel. When the stereo earphone is worn by a user, the left earphone contacts a left ear of the user, and the right earphone contacts a right ear of the user, so that the left ear receives the left channel and the right ear receives the right channel. During wearing, a relative position between the left earphone and the right earphone cannot be interchanged; otherwise, fidelity of a sound source and resolution of audio frequencies will be directly affected.

To achieve a perfect sound quality output effect, a user needs to confirm left and right sides before wearing the clip-on earphone. A current solution is to mark identifiers such as “L” and “R” on the clip-on earphone. However, this requires manual confirmation to avoid reverse wearing, which brings inconvenience to the user.

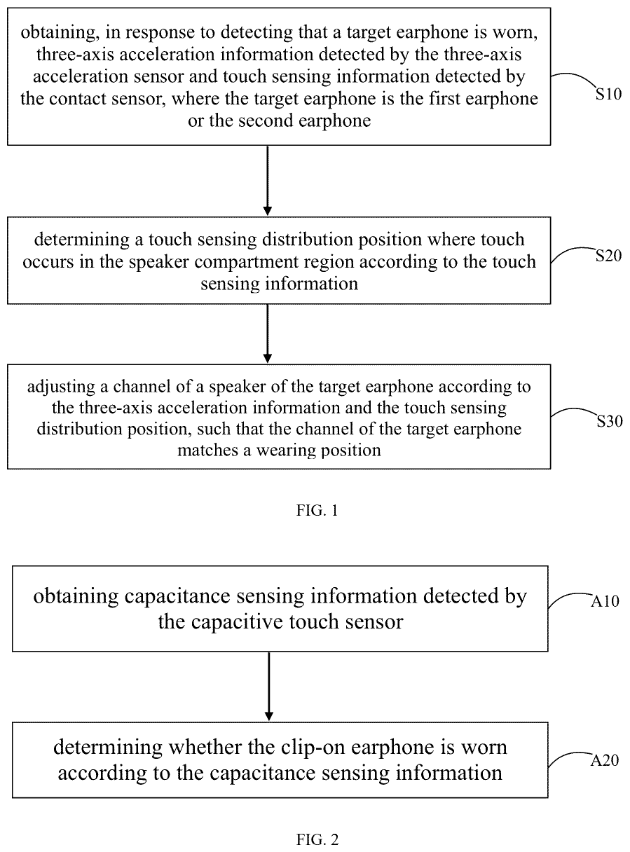

Based on this, as shown in FIG. 1, which is a flowchart of a method for matching left and right channels of earphones according to an embodiment of the present application. The method for matching left and right channels of earphones is applied to clip-on earphones, where the clip-on earphones include two single earphones, namely a first earphone and a second earphone. The first earphone and the second earphone of the clip-on earphones are each provided with a three-axis acceleration sensor, and speaker compartment regions of the first earphone and the second earphone are each provided with a contact sensor. The method includes:

Step S10, obtaining, in response to detecting that a target earphone is worn, three-axis acceleration information detected by the three-axis acceleration sensor and touch sensing information detected by the contact sensor, where the target earphone is the first earphone or the second earphone.

As those skilled in the art will appreciate, a three-axis acceleration sensor operates based on a basic principle of acceleration, where acceleration is a spatial vector.

In this embodiment, a type of the contact sensor may be a capacitive touch sensor or a resistive touch sensor.

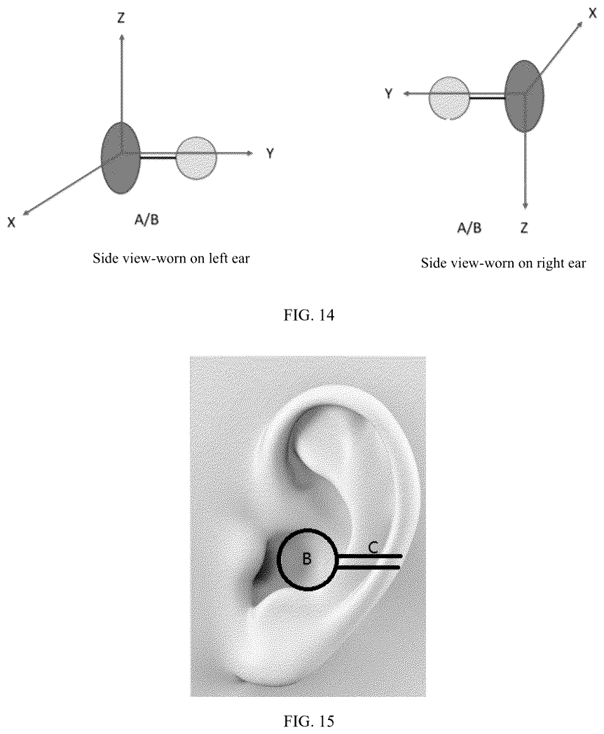

As shown in FIG. 13 and FIG. 14, FIG. 13 illustrates a clip-on earphone in one view according to an embodiment of the present application, and FIG. 14 illustrates the clip-on earphone in another view according to an embodiment of the present application. A single earphone includes a speaker compartment 3, a behind-the-ear compartment 1, and a connecting bridge 2 connecting the speaker compartment and the behind-the-ear compartment. A speaker compartment region refers to a region corresponding to the speaker compartment 3. It is understood by those skilled in the art that for a clip-on earphone, an acoustic module is generally provided in the speaker compartment 3. The acoustic module includes a speaker, and may further include a microphone, which is not specifically limited in this embodiment. The behind-the-ear compartment 1 generally includes a power supply module configured to provide power. The behind-the-ear compartment 1 may further include a noise reduction module and a communication module, which are not specifically limited in this embodiment. The speaker is used to play audio of a left channel or a right channel, and the power supply module is used to provide power for the single earphone. The communication module is used for information interaction between the single earphone and other electronic devices connected for communication with the single earphone. The acceleration sensor is used to detect three-axis acceleration information of the single earphone. The microphone is used to collect ambient audio, and the noise reduction module is used to perform adaptive noise reduction based on a preset noise reduction algorithm on the ambient audio collected by the microphone. The preset noise reduction algorithm may be an Active Noise Control (ANC) algorithm, an Environmental Noise Cancellation (ENC) algorithm, a Digital Signal Processing (DSP) algorithm, or a Clear Voice Capture (CVC) algorithm. For these noise reduction algorithms, those skilled in the art have conducted in-depth research, and thus details are not repeated herein.

In this embodiment, a type of the contact sensor is a capacitive touch sensor or a resistive touch sensor. The contact sensor is disposed in a speaker compartment region. For hardware principles of the capacitive touch sensor and the resistive touch sensor, those skilled in the art have conducted certain in-depth research, and therefore they will not be described in detail herein.

Step S20, determining a touch sensing distribution position where touch occurs in the speaker compartment region according to the touch sensing information.

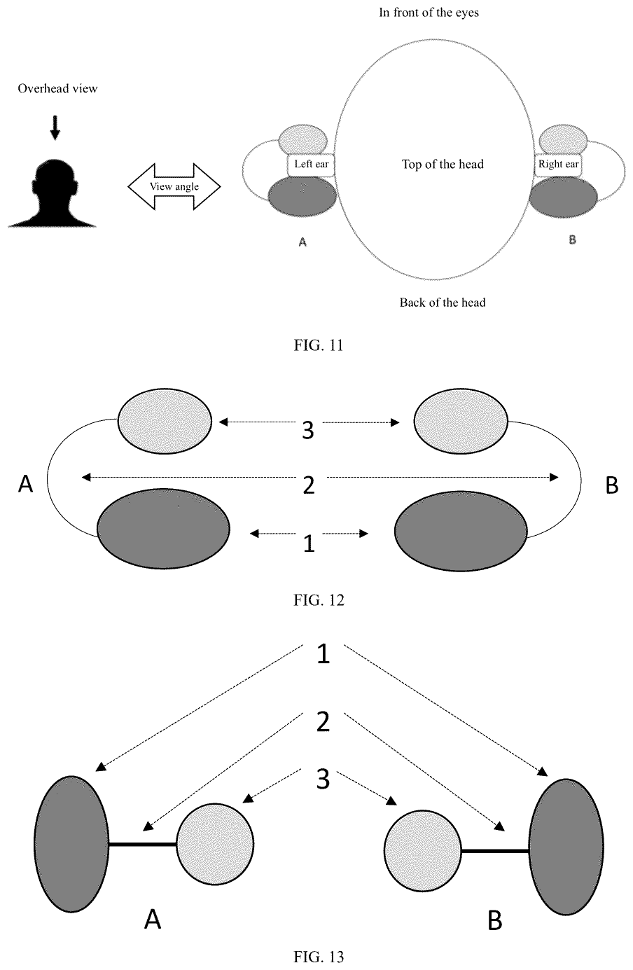

It can be understood that, after the clip-on earphones are worn, a part of the clip-on earphones will come into contact with an ear portion. When the target earphone switches from being worn on a left ear to being worn on a right ear, its posture will be flipped. That is, when the target earphone is worn on the left ear, a contact region corresponding to the left ear is a first region. When the target earphone is worn on the right ear, due to the posture of the target earphone being flipped (about 180 degrees), a contact region corresponding to the right ear will become a second region. The first region is different from the second region, as shown in FIG. 11 and FIG. 12, where FIG. 11 is a schematic diagram of a wearing posture of the clip-on earphones in a worn state from one view, and FIG. 12 is a schematic diagram of the clip-on earphones in one view according to an embodiment of the present application.

In this embodiment, a mapping relationship among a contact region corresponding to the touch sensing information (that is, the touch sensing distribution position), the three-axis acceleration information, and wearing position information may be stored in the target earphone in advance or stored in a cloud server in which the target earphone is registered and logged in. In an example, the mapping relationship stored in the target earphone or stored in the cloud server in which the target earphone is registered and logged in is as follows: in response to that the contact region corresponding to the touch sensing information is the first region and a component direction of the three-axis acceleration information in a vertical direction is a positive direction of a Z axis, the wearing position information corresponding to an association between the two is a left ear wearing position; and in response to that the contact region corresponding to the touch sensing information is the second region and the component direction of the three-axis acceleration information in the vertical direction is a negative direction of the Z axis, the wearing position information corresponding to the association between the two is a right ear wearing position. Based on the stored mapping relationship, it is convenient to subsequently determine a wearing position corresponding to the first earphone according to the three-axis acceleration information and the touch sensing information.

Step S30, adjusting a channel of a speaker of the target earphone according to the three-axis acceleration information and the touch sensing distribution position, such that the channel of the target earphone matches a wearing position.

In an embodiment, the contact sensor includes a touch sensing band used for sensing a tactile region, and the touch sensing band is attached to the speaker compartment region.

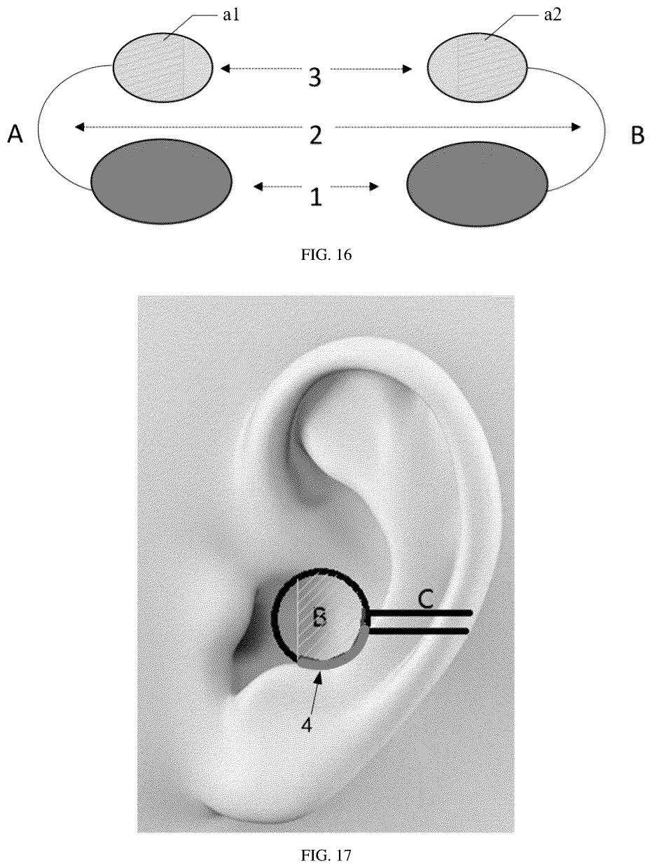

In this embodiment, as shown in FIG. 16 and FIG. 17, FIG. 16 is a schematic structural diagram of a target earphone in an example of the present application, and FIG. 17 is a diagram showing touch sensing of a touch sensing band of the target earphone in a wearing scenario in an example of the present application. The target earphone includes a speaker compartment 3, a behind-the-ear compartment 1, and a connecting bridge 2 connecting the speaker compartment 3 and the behind-the-ear compartment 1. The speaker compartment region refers to a region corresponding to the speaker compartment 3. The touch sensing band for sensing a tactile region is an oblique shaded region shown in FIG. 16 and FIG. 17, for example, oblique shaded regions labeled as a1 and a2 in FIG. 16. A region labeled by an arrow 4 in FIG. 17 in the touch sensing band and a concha side where the touch sensing band fits against an ear are both touch sensing distribution positions.

The embodiments of the present application disclose a method for matching left and right channels of earphones, a clip-on earphone, and a storage medium. The method for matching left and right channels of earphones is applied to clip-on earphones, where a first earphone and a second earphone of the clip-on earphones are each provided with a three-axis acceleration sensor, and speaker compartment regions of the first earphone and the second earphone are each provided with a contact sensor. A technical solution of the method for matching left and right channels of earphones of the present application is that, in response to detecting that a target earphone is worn, three-axis acceleration information detected by the three-axis acceleration sensor and touch sensing information detected by the contact sensor are obtained, where the target earphone is the first earphone or the second earphone, and a touch sensing distribution position where touch occurs in the speaker compartment region is determined according to the touch sensing information. Then, a channel of a speaker of the target earphone is adjusted according to the three-axis acceleration information and the touch sensing distribution position such that the channel of the target earphone matches a wearing position, such that a left channel corresponds to the earphone in a left ear wearing position and a right channel corresponds to the earphone in a right ear wearing position. In this way, automatic matching between left and right channels and left and right ears is implemented. This overcomes an inconvenience in related technologies that identifiers such as “L” and “R” need to be labeled on the earphones and manually confirmed in advance to avoid wearing them incorrectly, thereby improving the use convenience of the clip-on earphones. The method effectively enables a user to obtain correct left and right channel audio signals regardless of how the clip-on earphones are worn, without needing to distinguish left and right channels before wearing the earphones, thereby improving the user's auditory experience.

It is worth mentioning that, if the wearing position corresponding to the target earphone is determined only by detecting the three-axis acceleration information of the target earphone through a three-axis acceleration sensor and determining the wearing position corresponding to the target earphone according to the three-axis acceleration information, for example, in response to that a component direction of the three-axis acceleration information in a vertical direction is a positive direction of a Z axis, determining that wearing posture information corresponding to the target earphone is a first posture, and in response to that a component direction of the three-axis acceleration information in the vertical direction is a negative direction of the Z axis, determining that wearing posture information corresponding to the target earphone is a second posture. Then, in response to that the wearing posture information is the first posture, determining that the wearing position corresponding to the target earphone is a left ear wearing position, and in response to that the wearing posture information is the second posture, determining that the wearing position corresponding to the target earphone is a right ear wearing position, and then based on the wearing positions corresponding to the first earphone and the second earphone, adjusting left and right channels of a speaker of the clip-on earphones such that the left channel corresponds to the earphone in the left ear wearing position. However, in a process of identifying the wearing position of the target earphone only through the three-axis acceleration sensor, there may be a possibility of misidentification due to some special scenarios. For example, when a person wears the earphones, the head is not upright but in an unconventional posture such as being inverted or lying down. In this case, the wearing position of the target earphone cannot be accurately identified. Particularly, when the head is in an inverted posture, the identified wearing position may be exactly opposite, resulting in incorrect identification.

Based on this, in the embodiments of the present application, by integrating acceleration sensor information of the target earphone and touch sensing information (where the touch sensing information specifically refers to a touch sensing distribution position), a user can complete wearing in any posture and perform autonomous and correct detection. Left and right channels of the earphones will no longer change due to movement of the user's head, thereby further improving stability and robustness of the method for matching left and right channels of earphones in the embodiments of the present application.

In an embodiment, the first earphone and the second earphone are each further provided with a capacitive touch sensor, as shown in FIG. 2, and the method further includes:

Step A10, obtaining capacitance sensing information detected by the capacitive touch sensor; and

Step A20, determining whether the clip-on earphone is worn according to the capacitance sensing information.

The present application obtains capacitance sensing information detected by the capacitive touch sensors, and accurately detects whether the ear clip earphones are worn based on the capacitance sensing information.

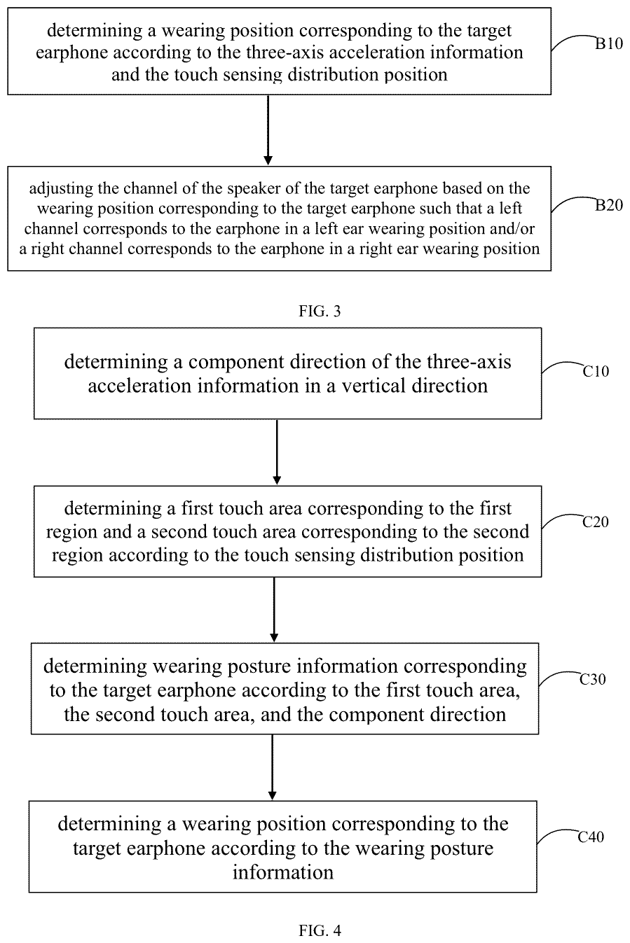

As shown in FIG. 3, in an embodiment, adjusting a channel of a speaker of the target earphone according to the three-axis acceleration information and the touch sensing distribution position includes:

Step B10, determining a wearing position corresponding to the target earphone according to the three-axis acceleration information and the touch sensing distribution position; and

Step B20, adjusting the channel of the speaker of the target earphone based on the wearing position corresponding to the target earphone such that a left channel corresponds to the earphone in a left ear wearing position and/or a right channel corresponds to the earphone in a right ear wearing position.

As shown in FIG. 11, FIG. 11 is a schematic diagram of a wearing posture of the clip-on earphones in a worn state from one view in an embodiment of the present application (viewed from top to bottom). The first earphone and the second earphone as two single earphones are identical, and a user does not need to manually distinguish left and right ears and can wear them arbitrarily. The earphones can automatically distinguish and configure left and right channels according to a left-side or right-side wearing position of the user. Regardless of a posture of the user's head when wearing the earphones, including an upright posture, a lying posture, and an inverted posture, an autonomous detection scheme for left and right channels of open earphones can be implemented through the method for matching left and right channels of earphones in the embodiments of the present application, facilitating wearing and use by the user. The user no longer needs to distinguish left and right and can wear the earphones blindly, effectively ensuring stability and robustness of the method for matching left and right channels of earphones in the embodiments of the present application.

In an embodiment, a single acceleration sensor may be disposed in a behind-the-ear compartment, and coordinate calibration may be performed at the factory in a normal wearing posture. For example, coordinate calibration may be performed on each single earphone in the same manner, and a Z axis is calibrated to point upward in the normal wearing posture. It is defined that when the earphones are worn normally, in response to detecting that the Z axis points upward, a left channel is defined, as shown in FIG. 14, which is a diagram showing three-axis acceleration information when clip-on earphones are worn on left and right ears in an embodiment of the present application. FIG. 14 illustrates a side view when worn on a left ear. When worn, in response to detecting that the Z axis points downward, a right channel is defined, as illustrated in a side view when worn on a right ear in FIG. 14. When worn in a correct posture by a user, one earphone must have the Z axis pointing upward and the other earphone must have the Z axis pointing downward, thereby completing configuration of left and right channels. After the clip-on earphones leave the factory, recognition of left and right channels needs to be completed in conjunction with a wearing detection function of acceleration sensing data of the earphones.

In the embodiments of the present application, a wearing position corresponding to the target earphone is determined according to the three-axis acceleration information and the touch sensing distribution position, and then based on the wearing position corresponding to the target earphone, a channel of a speaker of the target earphone is adjusted such that a left channel corresponds to the earphone in a left ear wearing position and/or a right channel corresponds to the earphone in a right ear wearing position, thereby implementing automatic matching between left and right channels and left and right ears. This overcomes an inconvenience in related technologies that identifiers such as “L” and “R” need to be labeled on the earphones and manually confirmed in advance to avoid wearing them incorrectly, thereby improving the use convenience of the clip-on earphones.

As shown in FIG. 4, in an embodiment, the speaker compartment region includes a first region and a second region opposite to the first region, and determining a wearing position corresponding to the target earphone according to the three-axis acceleration information and the touch sensing distribution position includes:

Step C10, determining a component direction of the three-axis acceleration information in a vertical direction;

Step C20, determining a first touch area corresponding to the first region and a second touch area corresponding to the second region according to the touch sensing distribution position; and

Step C30, determining wearing posture information corresponding to the target earphone according to the first touch area, the second touch area, and the component direction.

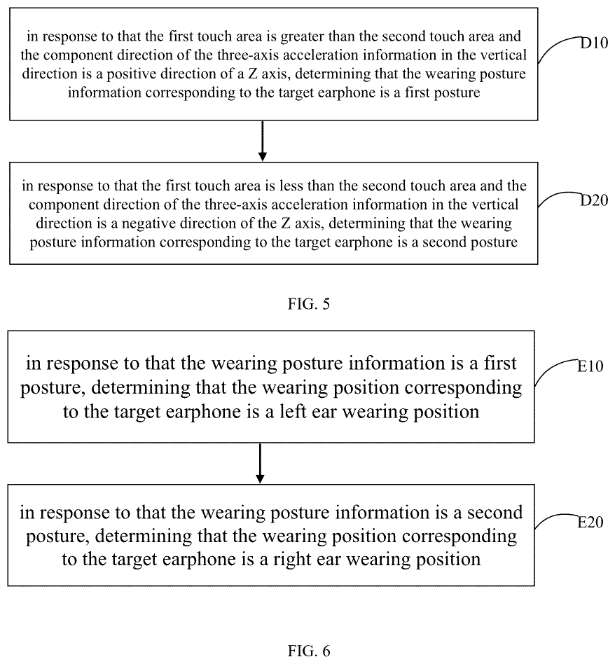

As shown in FIG. 5, in an embodiment, determining the wearing posture information corresponding to the target earphone according to the first touch area, the second touch area, and the component direction includes:

Step D10, in response to that the first touch area is greater than the second touch area and the component direction of the three-axis acceleration information in the vertical direction is a positive direction of a Z axis, determining that the wearing posture information corresponding to the target earphone is a first posture;

Step D20, in response to that the first touch area is less than the second touch area and the component direction of the three-axis acceleration information in the vertical direction is a negative direction of the Z axis, determining that the wearing posture information corresponding to the target earphone is a second posture.

After Step C30, Step C40 is performed, determining a wearing position corresponding to the target earphone according to the wearing posture information.

The first touch area refers to a touch area corresponding to the first region, and the second touch area refers to a touch area corresponding to the second region.

In the embodiments of the present application, since a wearing posture of the target earphone is inverted when the target earphone is converted from being worn on a left ear to being worn on a right ear. That is, when the target earphone is worn on the left ear, a main contact region corresponding to the left ear is the first region, that is, a first touch area corresponding to the first region in the touch sensing distribution position is greater than a second touch area corresponding to the second region. When the target earphone is worn on the right ear, since the wearing posture of the target earphone is inverted (about 180 degrees), a main contact region corresponding to the right ear becomes the second region, and the first region is different from the second region. That is, the first touch area corresponding to the first region in the touch sensing distribution position being greater than the second touch area is converted to the first touch area being less than the second touch area. For ease of understanding, please refer to FIG. 16. FIG. 16 illustrates two single earphones (i.e., a first earphone and a second earphone), where structures of the two single earphones are identical. A single earphone A illustrates the first region a1, and a single earphone B illustrates the second region a2. The first region a1 and the second region a2 are oppositely provided on a surface region of a speaker compartment 3 to form an enclosing trend around the speaker compartment 3.

The touch sensing distribution position of the touch sensing information and the three-axis acceleration information may be predetermined and stored with a mapping relationship with wearing position information in the target earphone, or stored in a cloud server that is registered and logged in with the target earphone. In an example, the mapping relationship stored in the target earphone or the cloud server that is registered and logged in with the target earphone is as follows: if the first touch area is greater than the second touch area and a component of the three-axis acceleration information in a vertical direction points to a positive direction of a Z axis, the wearing position information mapped by the two is a left ear wearing position; and if the first touch area is less than the second touch area and the component of the three-axis acceleration information in the vertical direction points to a negative direction of the Z axis, the wearing position information mapped by the two is a right ear wearing position. Based on the stored mapping relationship, determination of the wearing position corresponding to the first earphone according to the three-axis acceleration information and the touch sensing distribution position is facilitated.

In the embodiments of the present application, an open earphone is provided that does not require a user to distinguish between a left ear and a right ear during wearing, and the earphone can autonomously identify left and right channels during wearing, thereby avoiding a problem that the user needs to distinguish between left and right earphones before wearing.

As shown in FIG. 6, in an embodiment, determining a wearing position corresponding to the target earphone according to the wearing posture information includes:

Step E10, in response to that the wearing posture information is a first posture, determining that the wearing position corresponding to the target earphone is a left ear wearing position;

Step E20, in response to that the wearing posture information is a second posture, determining that the wearing position corresponding to the target earphone is a right ear wearing position.

In this embodiment, the first posture is different from the second posture. It can be understood that the second posture is formed by a 180-degree rotation or an approximately 180-degree rotation of the first posture. In an embodiment, as shown in FIG. 14, the left view in FIG. 14 illustrates a first posture corresponding to a target earphone when worn on a left ear, and the right view in FIG. 14 illustrates a second posture corresponding to the target earphone when worn on a right ear. The target earphone is the first earphone or the second earphone.

In the embodiments of the present application, when the wearing posture information is the first posture, the wearing position corresponding to the target earphone is determined to be a left ear wearing position, and when the wearing posture information is the second posture, the wearing position corresponding to the target earphone is determined to be a right ear wearing position. In this way, accuracy in identifying earphone wearing positions is effectively improved. By allowing the left channel to correspond to the earphone in a left ear wearing position and the right channel to correspond to the earphone in a right ear wearing position, automatic matching between the left and right channels and the left and right ears is achieved, so that users do not need to distinguish between left and right channels before wearing the earphones, and regardless of how the clip-on earphones are worn, the obtained left and right channel sound signals are always correct.

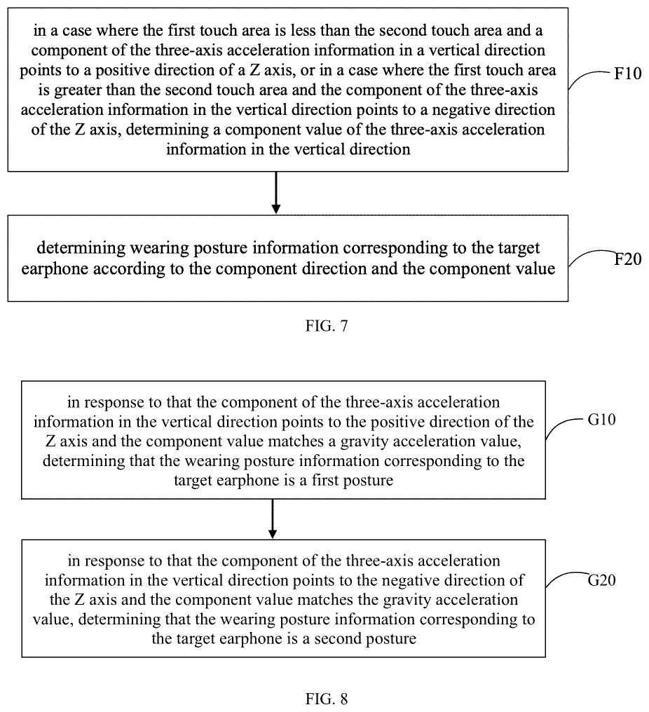

Based on the above embodiment of the present application, as shown in FIG. 7, in an embodiment, the method includes:

Step F10, in a case where the first touch area is less than the second touch area and a component of the three-axis acceleration information in a vertical direction points to a positive direction of a Z axis, or in a case where the first touch area is greater than the second touch area and the component of the three-axis acceleration information in the vertical direction points to a negative direction of the Z axis, determining a component value of the three-axis acceleration information in the vertical direction;

Step F20, determining wearing posture information corresponding to the target earphone according to the component direction and the component value.

As shown in FIG. 8, in an embodiment, determining the wearing posture information corresponding to the target earphone according to the component direction and the component value includes:

Step G10, in response to that the component of the three-axis acceleration information in the vertical direction points to the positive direction of the Z axis and the component value matches a gravity acceleration value, determining that the wearing posture information corresponding to the target earphone is a first posture;

Step G20, in response to that the component of the three-axis acceleration information in the vertical direction points to the negative direction of the Z axis and the component value matches the gravity acceleration value, determining that the wearing posture information corresponding to the target earphone is a second posture.

In the embodiments of the present application, as those skilled in the art will appreciate, since when a person wears earphones, the head of the person is generally in an upright state (and rarely in a lying or inverted state), a component value in a Z-axis direction generally matches a gravity acceleration value. Based on this principle, in the embodiments of the present application, in a case where a component of the three-axis acceleration information corresponding to the target earphone points to a positive direction of a Z axis and a component value in the positive direction of the Z axis matches the gravity acceleration value, the wearing posture information corresponding to the target earphone is determined to be a first posture; and in a case where the component of the three-axis acceleration information corresponding to the target earphone points to a negative direction of the Z axis and a component value in the negative direction of the Z axis matches the gravity acceleration value, the wearing posture information corresponding to the target earphone is determined to be a second posture. Therefore, accuracy of identifying a wearing position of the earphone is further improved, and automatic matching between left and right channels and left and right ears is implemented by enabling a left channel to correspond to the earphone in a left ear wearing position and enabling a right channel to correspond to the earphone in a right ear wearing position, so that there is no need to distinguish the left channel and the right channel before wearing the earphones, and regardless of how the clip-on earphones are worn, sound signals obtained for the left and right channels are always correct.

As shown in FIG. 9, in an embodiment, after determining the component value of the three-axis acceleration information in the vertical direction, further including:

Step H10, in response to that the component value matches a gravity acceleration value, performing the step of determining the wearing posture information corresponding to the target earphone according to the component direction and the component value;

Step H20, in response to that the component value does not match the gravity acceleration value, determining wearing posture information corresponding to a reference earphone; determining the wearing posture information corresponding to the target earphone according to the wearing posture information corresponding to the reference earphone, where the reference earphone is another earphone corresponding to another channel relative to the target earphone in the clip-on earphones.

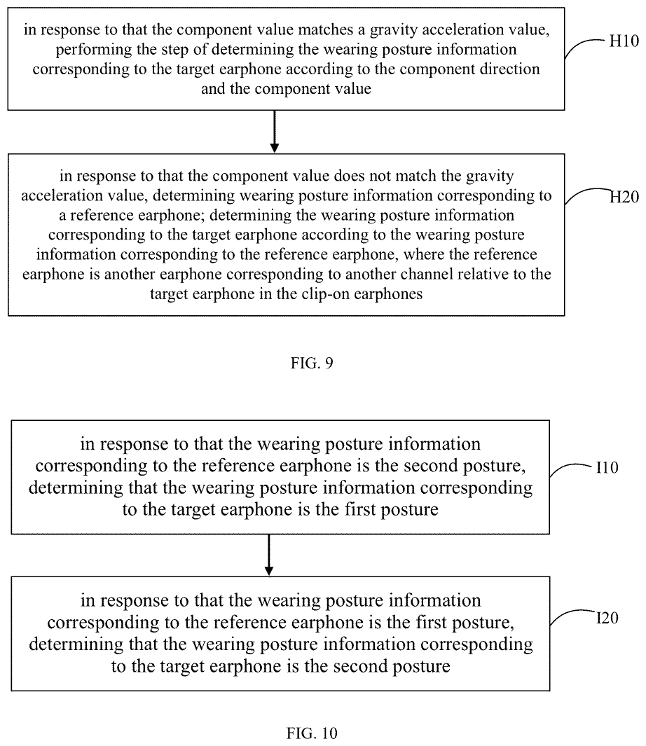

As shown in FIG. 10, in an embodiment, determining the wearing posture information corresponding to the target earphone according to the wearing posture information corresponding to the reference earphone includes:

Step 110, in response to that the wearing posture information corresponding to the reference earphone is the second posture, determining that the wearing posture information corresponding to the target earphone is the first posture;

Step 120, in response to that the wearing posture information corresponding to the reference earphone is the first posture, determining that the wearing posture information corresponding to the target earphone is the second posture.

Since it is possible that a wearing posture information of the target earphone still cannot be effectively detected even by integrating the acceleration sensor information and the touch sensing information (for example, due to a sensor failure of one earphone or other special factors), a wearing posture of the target earphone may be assisted in being determined by combining a wearing posture of the other earphone. It is easily understood that when both earphones are in a worn state, if one earphone is worn on a left ear, the other earphone must be worn on a right ear, and if one earphone is worn on a right ear, the other earphone must be worn on a left ear.

Based on this, in the embodiments of the present application, in a case where the component value does not match the gravity acceleration value, wearing posture information corresponding to a reference earphone is determined, and the wearing posture information corresponding to the target earphone is determined according to the wearing posture information corresponding to the reference earphone, where the reference earphone is another earphone corresponding to another channel relative to the target earphone in the clip-on earphones. Therefore, even in a case where the wearing posture of the target earphone still cannot be effectively detected by integrating the acceleration sensor information and the touch sensing information, the wearing position of the earphone can still be accurately identified, thereby facilitating accurate automatic matching of left and right channels with left and right ears subsequently by enabling a left channel to correspond to the earphone in a left ear wearing position and enabling a right channel to correspond to the earphone in a right ear wearing position.

To further facilitate understanding of the technical concept of the present application, a specific embodiment is listed, including:

As shown in FIG. 11, FIG. 11 is a schematic diagram of a wearing posture of the clip-on earphones in a worn state from one view in an embodiment of the present application (viewed from top to bottom). The first earphone and the second earphone as two single earphones are identical, and a user does not need to manually distinguish left and right ears and can wear them arbitrarily. The earphones can automatically distinguish and configure left and right channels according to a left-side or right-side wearing position of the user. Since when the earphones are first worn, the head of the user is generally in an upright posture rather than a lying or inverted posture, an autonomous detection scheme for left and right channels of open earphones is easily implemented through the method for matching left and right channels of earphones in the embodiments of the present application, facilitating wearing and use by the user. The user no longer needs to distinguish left and right and can wear the earphones blindly. In addition, structures of the clip-on earphones in the embodiments of the present application are simple, and hardware implementation cost of the method for matching left and right channels of earphones is low.

In an embodiment, a single acceleration sensor may be disposed in a behind-the-ear compartment, and coordinate calibration may be performed at the factory in a normal wearing posture. For example, coordinate calibration may be performed on each single earphone in the same manner, and a Z axis is calibrated to point upward in the normal wearing posture. It is defined that when the earphones are worn normally, in response to detecting that the Z axis points upward, a left channel is defined, as shown in a side view when worn on a left ear in FIG. 14. When worn, in response to detecting that the Z axis points downward, a right channel is defined, as illustrated in a side view when worn on a right ear in FIG. 14. When worn in a correct posture by a user, one earphone must have the Z axis pointing upward and the other earphone must have the Z axis pointing downward, thereby completing configuration of left and right channels. After the clip-on earphones leave the factory, recognition of left and right channels needs to be completed in conjunction with a wearing detection function of acceleration sensing data of the earphones.

If the user wears the earphones in a non-normal posture such as a lying posture or an inverted posture, in this case, merely relying on the acceleration sensor may cause misjudgment and thus fail to accurately configure left and right channels.

To solve the problem that the earphones can accurately identify and configure left and right channels when the user wears the earphones in different postures, a contact sensor is added to a speaker compartment.

FIG. 15 is a schematic diagram of a user wearing the target earphone in an embodiment of the present application, where B represents the speaker compartment and C represents a C-shaped connecting bridge.

In FIG. 16, a hatched region of the speaker compartment represents a touch sensing band region of the contact sensor, which is attached to a hatched annular region. As shown in FIG. 17. FIG. 17 is a diagram showing touch sensing of the touch sensing band in a wearing scenario of the target earphone in an example of the present application. When the earphone is worn, a bottom of the speaker compartment contacts a protrusion of an inner contour of an ear, namely a region indicated by reference 4 in FIG. 17, and an upper portion of the speaker compartment does not detect a touch signal (that is, touch sensing information) due to absence of skin contact. Similar to coordinate definition of the acceleration sensor, it is defined that in this case the left channel is used; when a touch sensor detects a touch signal at an upper portion of the speaker compartment in FIG. 17 and no touch signal is detected at a lower portion, the earphone is worn on a right ear at this time, that is, the right channel is used. It should be noted that this specific embodiment is only used to facilitate understanding of the technical concept of the present application and does not constitute a limitation to the present application. More simple variations made based on the technical concept of the present application shall fall within the protection scope of the present application.

Embodiments of the present application further provide a clip-on earphones, which includes a memory, a processor, a behind-the-ear compartment, a speaker compartment, and a connecting bridge configured to connect the behind-the-ear compartment and the speaker compartment, where the speaker compartment is provided with an acoustic module including a speaker and provided with a contact sensor, and the behind-the-ear compartment is provided with a power supply module and an acceleration sensor; the power supply module is configured to provide power to the clip-on earphone;
the acceleration sensor is configured to detect three-axis acceleration information of the clip-on earphone; the contact sensor is configured to detect the touch sensing information the memory is configured to store a program for matching left and right channels of earphones; and the processor is configured to execute the program for matching left and right channels of earphones and, when executing the program for matching left and right channels of earphones, implement the method for matching left and right channels of earphones in the above embodiments.

The clip-on earphone provided in the embodiment of the present application adopts the method for matching left and right channels of earphones described in the above embodiment, which can solve the technical problem in the related art that manual confirmation is required to determine whether the left and right earphones are worn reversely, resulting in poor convenience in using the clip-on earphones. Compared with the prior art, the advantageous effects of the clip-on earphone provided in this embodiment are the same as those of the method for matching left and right channels of earphones described in the above embodiment, and other technical features of the clip-on earphone are the same as those disclosed in the previous embodiment of the method, which will not be repeated here.

It should be understood that each part of the present disclosure can be implemented by hardware, software, firmware, or a combination thereof. In the description of the above embodiments, specific features, structures, materials, or characteristics may be combined in any suitable manner in one or more embodiments or examples.

The foregoing description is merely specific embodiments of the present application and is not intended to limit the protection scope of the present application. Any person skilled in the art can easily conceive of variations or substitutions within the scope of the technologies disclosed in the present application, which shall all fall within the protection scope of the present application. Therefore, the protection scope of the present application shall be subject to the protection scope of the claims.

The embodiment of the present application provides a computer-readable storage medium having computer-readable program instructions stored thereon, the computer-readable program instructions being used to execute the method for matching left and right channels of earphones described in the above embodiment.

The computer-readable storage medium provided in the embodiment of the present application may be, for example, a USB flash drive, but is not limited to electrical, magnetic, optical, electromagnetic, infrared, or semiconductor systems, devices, or apparatuses, or any combination thereof. More specific examples of the computer-readable storage medium may include, but are not limited to: electrical connections having one or more wires, portable computer disks, hard disks, random access memory (RAM), read-only memory (ROM), erasable programmable read-only memory (EPROM) or flash memory, optical fibers, portable compact disc read-only memory (CD-ROM), optical storage devices, magnetic storage devices, or any suitable combination thereof. In this embodiment, the computer-readable storage medium may be any tangible medium that includes or stores a program, which can be used by or in combination with an instruction execution system, device, or apparatus. The program code contained on the computer-readable storage medium may be transmitted via any appropriate medium, including but not limited to: electrical wires, optical cables, radio frequency (RF), or any suitable combination thereof.

The above computer-readable storage medium may be included in the clip-on earphone or may exist independently without being assembled into the clip-on earphone.

The above computer-readable storage medium carries one or more programs. When the one or more programs are executed by the clip-on earphone, the clip-on earphone are enabled to: in response to detecting that a target earphone is worn, obtain three-axis acceleration information detected by the three-axis acceleration sensor and touch sensing information detected by the contact sensor, where the target earphone is the first earphone or the second earphone; determine a touch sensing distribution position where touch sensing is generated in a speaker compartment region according to the touch sensing information; and adjust a channel of a speaker of the target earphone according to the three-axis acceleration information and the touch sensing distribution position so that the channel of the target earphone matches a wearing position.

The computer program code for performing the operations of the present disclosure may be written in one or more programming languages or a combination thereof. The programming languages include object-oriented programming languages such as Java, Smalltalk, and C++, as well as conventional procedural programming languages such as the C language or similar programming languages. The program code may be executed entirely on a user computer, partly on a user computer, as a stand-alone software package, partly on a user computer and partly on a remote computer, or entirely on a remote computer or server. In cases involving a remote computer, the remote computer may be connected to the user computer through any type of network, including a local area network (LAN) or a wide area network (WAN), or may be connected to an external computer, for example, via the Internet using an Internet service provider.

The flowcharts and block diagrams in the drawings illustrate possible system architectures, functions, and operations for implementing the systems, methods, and computer program products according to various embodiments of the present application. In this regard, each block in the flowcharts or block diagrams may represent a module, a program segment, or a portion of code that includes one or more executable instructions for implementing the specified logical function. It should also be noted that, in some alternative implementations, the functions noted in the blocks may occur in an order different from that shown in the drawings. For example, two blocks shown in succession may in fact be executed substantially concurrently, or they may sometimes be executed in reverse order, depending on the functions involved. It should also be noted that each block in the block diagrams and/or flowcharts, as well as combinations of blocks in the block diagrams and/or flowcharts, may be implemented by a dedicated hardware-based system that performs the specified functions or operations, or by a combination of dedicated hardware and computer instructions.

The modules involved in the embodiments of the present disclosure may be implemented in software or hardware. The names of the modules do not constitute limitations on the modules themselves in certain cases.

The computer-readable storage medium provided in the present application stores computer-readable program instructions for executing the above method for matching left and right channels of earphones. The solution can address the technical problem in the related art that requires manually confirming whether the left and right earphones are worn correctly, which leads to poor usability of clip-on earphones. Compared with the prior art, the beneficial effects of the computer-readable storage medium provided in the embodiment of the present application are the same as those of the method for matching left and right channels of earphones provided in the above embodiment, and therefore will not be described further herein.

The embodiment of the present application further provides a computer program product including a computer program. When executed by a processor, the computer program implements the steps of the method for matching left and right channels of earphones as described above.

The computer program product provided in the present application can address the technical problem in the related art that requires manually confirming whether the left and right earphones are worn correctly, which leads to poor usability of clip-on earphones. Compared with the prior art, the beneficial effects of the computer program product provided in the embodiment of the present application are the same as those of the method for matching left and right channels of earphones provided in the above embodiment, and therefore will not be described further herein.

The above are only some embodiments of the present application, and do not limit the scope of the present application thereto. Under the inventive concept of the present application, equivalent structural transformations made based on the description and drawings of the present application, or direct/indirect application in other related technical fields are included in the scope of the present application.

What is claimed is:

1. A method for matching left and right channels of earphones, applied to a clip-on earphone, wherein a first earphone and a second earphone of the clip-on earphone are each provided with a three-axis acceleration sensor, and speaker compartment regions of the first earphone and the second earphone are each provided with a contact sensor, the method comprising:
obtaining, in response to detecting that a target earphone is worn, three-axis acceleration information detected by the three-axis acceleration sensor and touch sensing information detected by the contact sensor, wherein the target earphone is the first earphone or the second earphone;
determining a touch distribution position where touch occurs in the speaker compartment region according to the touch sensing information; and
adjusting a channel of a speaker of the target earphone according to the three-axis acceleration information and the touch distribution position, such that the channel of the target earphone matches a wearing position.

2. The method according to claim 1, wherein the adjusting the channel of the speaker of the target earphone according to the three-axis acceleration information and the touch distribution position comprises:
determining a wearing position corresponding to the target earphone according to the three-axis acceleration information and the touch distribution position; and
adjusting the channel of the speaker of the target earphone based on the wearing position corresponding to the target earphone, such that a left channel corresponds to the earphone in a left ear wearing position, and/or a right channel corresponds to the earphone in a right ear wearing position.

3. The method according to claim 2, wherein the speaker compartment region comprises a first region and a second region opposite to the first region, and the determining the wearing position corresponding to the target earphone according to the three-axis acceleration information and the touch distribution position comprises:
determining a component direction of the three-axis acceleration information in a vertical direction;
determining a first touch area corresponding to the first region and a second touch area corresponding to the second region according to the touch distribution position;
determining wearing posture information corresponding to the target earphone according to the first touch area, the second touch area, and the component direction; and
determining the wearing position corresponding to the target earphone according to the wearing posture information.

4. The method according to claim 3, wherein the determining the wearing posture information corresponding to the target earphone according to the first touch area, the second touch area, and the component direction comprises:
in response to that the first touch area is greater than the second touch area and a component direction of the three-axis acceleration information in the vertical direction is a positive direction of a Z axis, determining that wearing posture information corresponding to the target earphone is a first posture; and
in response to that the first touch area is less than the second touch area and the component direction of the three-axis acceleration information in the vertical direction is a negative direction of the Z axis, determining that wearing posture information corresponding to the target earphone is a second posture.

5. The method according to claim 3, further comprising:
in response to that the first touch area is less than the second touch area and the component direction of the three-axis acceleration information in the vertical direction is a positive direction of the Z axis, or
in response to that the first touch area is greater than the second touch area and the component direction of the three-axis acceleration information in the vertical direction is a negative direction of the Z axis, determining a component value of the three-axis acceleration information in the vertical direction; and
determining the wearing posture information corresponding to the target earphone according to the component direction and the component value.

6. The method according to claim 5, wherein the determining the wearing posture information corresponding to the target earphone according to the component direction and the component value comprises:
in response to that the component direction of the three-axis acceleration information in the vertical direction is the positive direction of the Z axis and the component value matches a gravity acceleration value, determining that the wearing posture information corresponding to the target earphone is the first posture; and
in response to that the component direction of the three-axis acceleration information in the vertical direction is the negative direction of the Z axis and the component value matches the gravity acceleration value, determining that the wearing posture information corresponding to the target earphone is the second posture.

7. The method according to claim 5, wherein after determining the component value of the three-axis acceleration information in the vertical direction, the method further comprises:
in response to that the component value matches a gravity acceleration value, determining the wearing posture information corresponding to the target earphone according to the component direction and the component value; and
in response to that the component value does not match the gravity acceleration value, determining wearing posture information corresponding to a reference earphone, and determining the wearing posture information corresponding to the target earphone according to the wearing posture information corresponding to the reference earphone, wherein the reference earphone is the earphone of another channel corresponding to the target earphone in the clip-on earphone.

8. The method according to claim 7, wherein the determining the wearing posture information corresponding to the target earphone according to the wearing posture information corresponding to the reference earphone comprises:
in response to that the wearing posture information corresponding to the reference earphone is the second posture, determining that the wearing posture information corresponding to the target earphone is the first posture; and
in response to that the wearing posture information corresponding to the reference earphone is the first posture, determining that the wearing posture information corresponding to the target earphone is the second posture.

9. The method according to claim 3, wherein the determining the wearing position corresponding to the target earphone according to the wearing posture information comprises:
in response to that the wearing posture information is the first posture, determining that the wearing position corresponding to the target earphone is a left ear wearing position; and
in response to that the wearing posture information is the second posture, determining that the wearing position corresponding to the target earphone is a right ear wearing position.

10. The method according to claim 1, wherein a type of the contact sensor is a capacitive touch sensor or a resistive touch sensor.

11. A clip-on earphone, comprising a memory, a processor, a behind-the-ear compartment, a speaker compartment, and a connecting bridge configured to connect the behind-the-ear compartment and the speaker compartment, wherein:
the speaker compartment is provided with an acoustic module and a contact sensor, the acoustic module comprises a speaker, and the behind-the-ear compartment is provided with a power supply module and an acceleration sensor;
the power supply module is configured to provide power to the clip-on earphone;
the acceleration sensor is configured to detect three-axis acceleration information of the clip-on earphone;
the contact sensor is configured to detect touch sensing information;
the memory is configured to store a program for matching left and right channels of earphones; and
the processor is configured to execute the program for matching left and right channels of earphones, and when executing the program for matching left and right channels of earphones, the method for matching left and right channels of earphones according to claim 1 is implemented.

12. A non-transitory computer-readable storage medium, on which a program for implementing a method for matching left and right channels of earphones is stored, wherein when the program for implementing the method for matching left and right channels of earphones is executed by a processor, the method for matching left and right channels of earphones according to claim 1 is implemented.
